(19) United States
(12) Patent Application Publication
(10) Pub. No.: US 2018/0276105 A1
(43) Pub. Date: Sep. 27, 2018

(54) ACTIVE LEARNING SOURCE CODE REVIEW FRAMEWORK

(71) Applicant: FUJITSU LIMITED, Kawasaki-shi (JP)

(72) Inventors: Ramya Malur SRINIVASAN, Sunnyvale, CA (US); Ajay CHANDER, San Francisco, CA (US)

(73) Assignee: FUJITSU LIMITED, Kawasaki-shi (JP)

(21) Appl. No.: 15/468,065

(22) Filed: Mar. 23, 2017

(51) Int. Cl. G06F 11/36

(52) U.S. Cl. CPC G06F 11/3612

(57) ABSTRACT

Technologies are described to provide an active learning source code review framework. In some examples, a method to review source code under this framework may include extracting semantic code features from a source code under review. The method may also include training an error classifier based on the extracted semantic code features, and selecting a candidate code section of the source code under review for discrete review. The method may further include facilitating discrete review of the selected candidate code section, updating the error classifier based on a result of the discrete review of the selected candidate code section, and generating an automated review of the source code under review based on the updating of the error classifier.

### FIELD

The described technology relates generally to code review.

### BACKGROUND

Source code, such as software source code, typically contains errors such as defects or mistakes in the code that, upon execution, may cause buffer overflows, memory leaks, or other such bugs. Source code review entails the examination of source code for such errors in order to improve the overall quality of the source code. Conventional source code review techniques are inefficient in that they are either labor intensive (i.e., require significant human effort to identify the errors) and require a significant amount of time or, while automated and more efficient with regards to time, are source code language specific and do not scale across multiple languages.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to some examples, methods to review source code utilizing active learning are described. An example method may include generating a semantic code feature from a source code under review. The method may also include training an error classifier based on the generated semantic code feature, and selecting a candidate code section of the source code under review for discrete review. The method may further include facilitating discrete review of the selected candidate code section, updating the error classifier based on a result of the discrete review of the selected candidate code section, and generating an automated review of the source code under review based on the updating of the error classifier.

The objects and advantages of the embodiments will be realized and achieved at least by the elements, features, and combinations particularly pointed out in the claims. Both the foregoing general description and the following detailed description are given as examples, are explanatory and are not restrictive of the invention, as claimed.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates selected components of an active learning source code review framework;

FIG. 2 illustrates selected components of an example active learning source code review system;

FIG. 3 illustrates selected components of an example general purpose computing system, which may be used to provide active learning source code review; and

FIG. 4 is a flow diagram that illustrates an example process to provide source code review utilizing active learning that may be performed by a computing system such as the computing system of FIG. 3;

all arranged in accordance with at least some embodiments described herein.

### DESCRIPTION OF EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to a framework, including methods, apparatus, systems, devices, and/or computer program products related to active learning source code review.

Technologies are described for an active learning source code review framework (interchangeably referred to herein as a “framework”). The active learning source code review framework incorporates concepts of active learning and automated code review, allowing for effective and efficient software code review. Source code may include different types of errors. In some embodiments, the framework allows extraction of semantic features from a source code (the source code under review), and utilizes the extracted semantic features to train an error classifier to identify probabilities of different or various kinds of errors in the source code under review. The framework incorporates active learning that utilizes information associated with the code patterns in the source code under review to identify code regions that may benefit from or need discrete or separate review. The framework then updates or retrains the error classifier with the results of any discrete review of an identified code region to improve the error classifier.

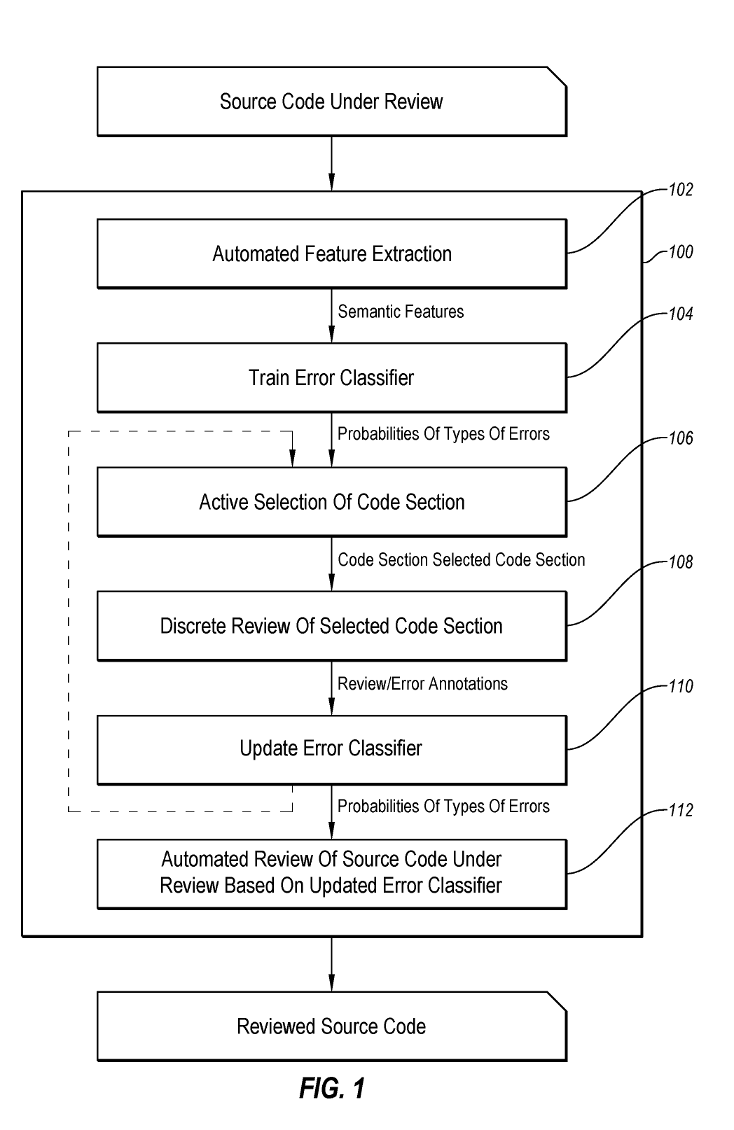

FIG. 1 illustrates selected components of an active learning source code review framework 100, arranged in accordance with at least some embodiments described herein. As depicted, framework 100 may include an automated feature extraction 102, a train error classifier 104, an active selection of code section 106, a discrete review of selected code section 108, an update error classifier 110, and an automated review of source code under review based on updated error classifier 112. Automated feature extraction 102 is the automated extraction of semantic features from a source code under review. The source code under review may be input or provided to framework 100 from an external source. The source code under review includes a defined syntax and semantic information, which may be latent. The syntax and sematic information may be utilized to automatically generate or learn the semantic features, which may be utilized to train an error classifier.

Train error classifier 104 is the training of an error classifier using the semantic features generated at automated feature extraction 102. The error classifier may be trained or learned for categories or types of errors, which allows the error classifier to predict or determine the probability of each category or type of error in the source code under review.

Active selection of code section 106 is a selection of a code section for discrete review from one or more code sections in the source code under review that may benefit from a discrete review (one or more candidate code sections). The selection of a code section (selected candidate code section) may be based on the probability or probabilities predicted from train error classifier 104. The selection of the code section for discrete review may be based on a comparison of (1) an expected value associated with the updating or retraining of the error classifier with the results of a discrete review of the code section, and (2) a predicted cost associated with performing or conducting the discrete review of the code section. In instances where the discrete review is being manually performed (e.g., a manual review), by, for example, a human reviewer, the predicted cost may be an estimate of a measure of time needed to manually perform or conduct the discrete review. The estimate of the measure of time may be automatically determined or generated, for example, using a supervised learning algorithm, or other suitable technique. The supervised learning algorithm may receive a code section as input and provide as output an estimated time requirement needed to perform a manual review of the input code section. Additionally or alternatively, the estimate of the measure of time may be provided by a human reviewer who may be performing or conducting the discrete review.

Discrete review of selected code section 108 is the discrete review of the code section selected at active selection of code sections 106. In some embodiments, the discrete review is a manual review as discussed above. The discrete review of a code section may generate annotations describing the discrete review and/or annotations for one or more errors included in the code section (error annotations/reviews). In some embodiments, the discrete review may be an automated review, for example, using a suitable source code review tool. In these instances, the predicted cost discussed above may be based on a cost associated with the source code review tool and/or execution of the source code review tool.

Update error classifier 110 is the updating or retraining of the error classifier using the error annotations/reviews generated at discrete review of selected code sections 108. The updated error classifier may predict or determine the probability of each category or type of error present in the source code under review given the error annotations/reviews generated at discrete review of selected code sections 108. Updating the error classifier in this manner provides for active learning of the error classifier, which may provide for an improved error classifier and/or an increase in efficiency of the error classifier, as well as other benefits.

Automated review of source code under review based on updated error classifier 112 is the automated review of the source code under review utilizing the updated classifier at update error classifier 110. The reviewed source code may be output or provided, for example, for review or processing. The output reviewed source code may include the error annotations/reviews described above.

In some embodiments, framework 100 may allow iteration of active selection of a code section 106, discrete review of the selected code section 108, and update error classifier 110 (as indicated by the dashed line in the drawing). This iteration allows for the discrete review of multiple code sections in the source code under review that may benefit from a discrete review, which may further improve the error classifier and/or further increase the efficiency of the error classifier, provide a more efficient, thorough, and/or complete review of the source code under review, as well as other benefits.

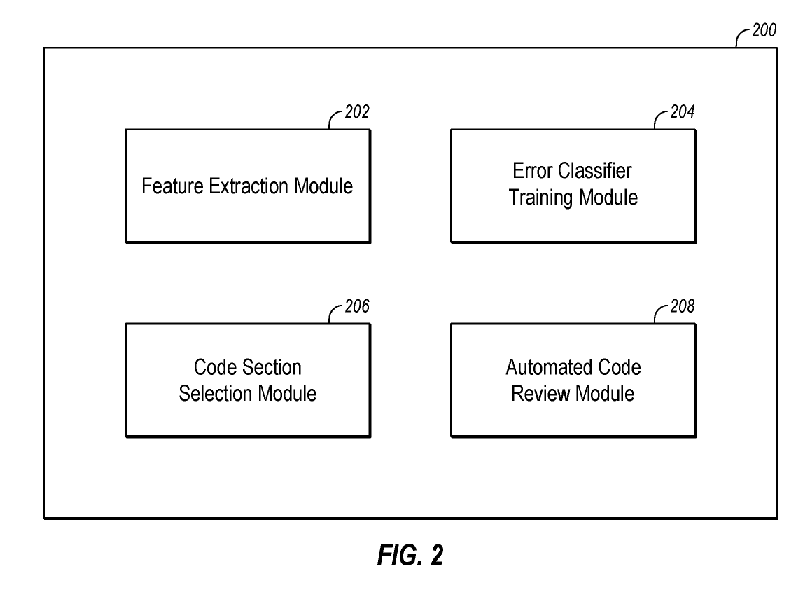

FIG. 2 illustrates selected components of an example active learning source code review system 200, arranged in accordance with at least some embodiments described herein. As depicted, active learning source code review system 200 may include a feature extraction module 202, an error classifier training module 204, a code section selection module 206, and an automated code review module 208. Active learning source code review system 200 may receive as input source code (i.e., source code under review) to be reviewed for defects or errors contained in the source code.

Feature extraction module 202 may be configured to analyze the source code under review to learn or extract sematic features of the source code under review. The learned semantic features may then be utilized to perform code defect or error prediction. In some embodiments, feature extraction module 202 may utilize a feature-learning algorithm, such as a Deep Belief Network (DBN), to learn the semantic features of the source code under review. DBNs are generative graphical models that use a multi-level neural network to learn a representation from training data that could reconstruct the semantic and content of input data.

The source code under review may include a well-defined syntax that may be represented using trees, such as abstract syntax trees (ASTs). Represented in this manner, the syntax may be utilized to determine coding or programming patterns in the source code under review. The source code under review may also include semantic information, which may be deep within the source code (e.g., latent). The semantic information may distinguish the various code sections or regions in the source code under review. Accordingly, ASTs that represent the source code under review may include token vectors that preserve the structural and contextual information of the source code under review. A DBN may be utilized to learn semantic features of the source code under review from the token vectors extracted from the ASTs that represent the source code under review.

A DBN includes an input layer, multiple hidden layers, and an output layer. Each layer may include multiple stochastic nodes. The output layer is the top layer of the DBN, and represents the features of the source code under review. In this context, the number of nodes of the output layer corresponds to the number of semantic features. The DBN is able to reconstruct the input data (e.g., the source code under review) using the generated semantic features by adjusting the weights (W) between the nodes in the different layers. The DBN may be trained by initializing the weights between the nodes in the different layers and initializing the associated biases (b) to zero (“0”). The weights and biases can then be tuned with respect to a specific criterion such as, by way of example, number of training iterations, error rate between input and output, etc. The fine-tuned weights and associated biases may be used to set up the DBN, allowing the DBN to generate the semantic features from the source code under review.

For example, a set of training codes and their associated labels may be denoted as {(X₁, L₁), (X₂, L₂), . . . , (X_{N}, L_{N})}. Each code Xᵢ may include a set of errors Xⁱ₁={xⁱ₂, xⁱ₂, . . . , xⁱₙᵢ} and Lᵢ={lⁱ₁, lⁱ₂, . . . , lⁱₘᵢ}, where nᵢ denotes the number of errors in code Xᵢ, and mᵢ denotes the number of errors labels for the errors. Multiple errors may have the same label and, thus, mᵢ may be smaller than nᵢ. Denoting the possible set of error labels associated with the training data L={1, . . . , C}, each error xⁱⱼ may be associated with a feature vector, ϕ(xⁱⱼ), which describes the error in terms of its occurrence.

Error classifier training module 204 may be configured to train an error classifier to predict probabilities of different types of errors in a source code under review using semantic features generated from the source code under review. The semantic features of the source code under review may be generated as discussed above with reference to feature extraction module 202. In some embodiments, the error classifier may be a Logistic Regression (LR) classifier. The semantic features of the source code under review, represented as feature vectors ϕ(xⁱⱼ), may be used to train the LR classifier for the categories of errors. Accordingly, given a new piece of code X_{new}, the LR classifier can predict a probability for each type of error, P(lₖ|ϕ(xⁱ_{new})) for k=1:C. The new piece of code may be the source code under review or a snippet or segment of the source code under review.

Code section selection module 206 may be configured to select a candidate code section from the source code under review that may benefit from a discrete review (also referred to herein as a “candidate annotation”), and facilitate discrete review of the selected candidate code section. A candidate code section may be selected from multiple code sections that may each benefit from a discrete review. A candidate code section may be selected based on the predicted probabilities for the various types of errors in the source code under review.

In some embodiments, for each of the multiple code sections that may each benefit from a discrete review, code section selection module 206 may determine a measure of expected information that results from a discrete review of a particular one of the multiple code sections, and a measure of predicted cost of conducting the discrete review of the particular one of the multiple code sections. Code section selection module 206 may subtract the measure of predicted cost from the measure of expected information to determine a relative value of information of conducting a discrete review of each of the multiple code sections that may benefit from a discrete review.

In some embodiments, code section selection module 206 may utilize a supervised leaning algorithm to determine a measure of predicted cost of conducting the discrete review of a code section. Suppose that different errors require different amounts of review time (i.e., different amounts of time to review). Code section selection module 206 may obtain response times of different reviewers, for example, different human reviewers, to perform a reviews of different errors, and train the supervised learning algorithm with these response times. Trained in this manner, the supervised learning algorithm can predict a time taken by an average reviewer (e.g., average human reviewer) to review a code section. Accordingly, a cost function, Cost(z), may be generated that receives as input a code section that may benefit from a discrete review (a candidate annotation z), and returns a predicted time requirement as output. The output predicted time requirement is the measure of predicted cost of conducting the discrete review. When z is a full piece of code (e.g., the entire source code under review), the cost function, Cost(z), may be with respect to the entire code. When z is a request for a single snippet or section within a code, the cost function, Cost(z), may be estimated as the full code's predicted cost (e.g., full code's review time) divided by the number of segments in the code. A reviewer may indicate or identify the number of segments.

In some embodiments, a measure of predicted cost of conducting a discrete review of a code section may be obtained from an external source. For example, code section selection module 206 may provide an interface, such as a user interface, through which a human reviewer may provide or specify a predicted time requirement to conduct a manual review of a code section.

Code section selection module 206 may use the generated cost function to define an active learning criterion. The active learning criterion can be used to select candidate code section or sections for discrete review. In some embodiments, code section selection module 206 may determine a measure to gauge the relative risk reduction (a risk reduction measure) a new discrete review may provide. The risk reduction measure may then be used to evaluate candidate code sections and types of review (type of annotation), and predict which combination of candidate code section and type of review will provide the desired net decrease in a risk associated with a current error classifier, when each choice is penalized according to its expected cost (e.g., expected cost of conducting the discrete review).

For example, at any stage in the active learning process, the source code under review may be divided into three different pools X_{U}, X_{R}, and X_{P}, denoting un-reviewed code sets, reviewed code sets, and partially reviewed code sets, respectively. Suppose rₗ denotes the risk associated with mis-reviewing an example (e.g., a candidate instance) belonging to class l. The risk associated with X_{R}, may be specified as:

R(X_{R})=Σ_{X}_{ᵢ}ϵ_{X}_{_{R}}Σₗϵ_{L}_{ᵢ}rₗ(1−p(l|Xᵢ)) [1]

where p(l|Xᵢ) is the probability that Xᵢ is classified with label l by the LR classifier. Suppose Xᵢ is a code with multiple errors the probability it receives label l as:

p(l|Xᵢ)=p(l|xⁱ₁,xⁱ₂, . . . ,xⁱₙᵢ)=1−Π_{j=1:n}_{ᵢ}(p(l|xⁱⱼ)) [2]

The corresponding risk with un-reviewed code is the probability that it does not have any errors belonging to class l. Accordingly, the risk associated with X_{U} may be specified as:

R(X_{U})=Σ_{Xi}ϵ_{X}_{_{U}}Σ_{C}rₗ(1−p(l|Xᵢ))Pr(l|Xᵢ) [3]

where p(l|Xᵢ) is the true probability that the un-reviewed code Xᵢ has label l, approximated as Pr(l|Xᵢ)≈p(l|Xᵢ), and p(l|Xᵢ) is computed using Equation [2] above. Similarly, the risk associated with partially reviewed code, X_{P}, may be specified as:

R(X_{P})=Σ_{Xi}ϵ_{X}_{_{P}}Σₗϵ_{Li}rₗ(1−p(l|Xᵢ))Pr(l|Xᵢ)+Σₗϵ_{Li}rₗ(1−p(l|Xᵢ))Pr(l|Xᵢ) [4]

where Uᵢ=L−Lᵢ.

A measure of expected information may be a measure of expected value to the error classifier discussed above. At each stage in the training process, an error classifier (i.e., the current error classifier) may have an associated risk, which is the risk of mis-reviewing code sections. A total cost, T(X_{R}, X_{U}, X_{P}), associated with a given snapshot of data may be calculated as a sum of the total miscalculation risk and the cost of obtaining all the labeled data thus far (i.e., the cost of obtaining all the discrete reviews thus far). The total cost may be specified as:

T(X_{R},X_{U},X_{P})=R(X_{R})+R(X_{U})+R(X_{P})+Σ_{Xi}ϵ_{X}_{_{B}}Σₗϵ_{Li}Cost(X^{l}ᵢ) [5]

where X_{B}=X_{R} U X_{P}, and the cost function may be determined as discussed above.

The utility of obtaining a particular error annotation/review (e.g., a discrete review of a particular code section) may be the change in total cost that would result from the addition of the annotation to X_{R}. Accordingly, the value of information, VOI, for an annotation/review z may be specified as:

VOI(z)=T(X_{R},X_{U},X_{P})−T(X′_{R},X′_{U},X′_{P})=R(X_{R})+R(X_{U})+R(X_{P})−(R(X′_{R})+R(X′_{U})+R(X′_{P}))−Cost(z) [6]

where X′_{R}, X′_{U}, X′_{P} denote the set of reviewed, un-reviewed, and partially reviewed code sets obtained from annotation/review of z. If z is a complete annotation, then X′_{R}=X_{R} U z; otherwise, X′_{P}=X_{P} U z, and the candidate instance is removed from X_{U} and X_{P}, as appropriate. That is, the expected values T(X′_{R}, X′_{U}, X′_{P}) in Equation [6] may be calculated by removing the candidate instance from the specific category, and adding it (the removed candidate instance) to the appropriate category, and calculating the using the updated error classifier (e.g., updated LR classifier).

As discussed above, a measure of predicted cost of performing a discrete review of a particular code section may be subtracted from a measure of expected information that results from the discrete review to determine a value of information of performing the discrete review of the particular code section. Accordingly, performing a discrete review of a code section that results in a higher value of information results in a higher reduction of the total cost as compared to performing a discrete review of a code section that results in a lower value of information. This value of information is the measure of benefit or improvement to the error classifier.

In some embodiments, a code section having the highest value of information resulting from a discrete review of the code section may be selected as a candidate code section. In other embodiments, code sections having values of information resulting from discrete reviews of the code sections that are larger than a specific value may be selected as candidate code sections. This may result in the selection of none, one or more candidate code sections. The specific value may be predetermined, for example, by code section selection module 206. In some embodiments, the specific value may be set to achieve a specific or desired level of performance. Additionally or alternatively, code section selection module 206 may provide an interface, such as a user interface or an application program interface, with which a user may specify, adjust and/or tune the specific value to achieve a desired level of performance. In some embodiments, code sections having values of information resulting from discrete reviews that causes a change to the total cost associated with the source code under review by at least a specified amount may be selected as candidate code sections.

In some embodiments, code section selection module 206 may provide an interface to facilitate discrete review of the selected candidate code section. For example, code section selection module 206 may provide a suitable user interface, such as a graphical user interface (GUI), which may be used to conduct a manual review of a selected candidate code section. A reviewer, such as a human reviewer, may use the user interface to access the selected candidate code section in order to conduct the review, and provide the results of the review (error annotation/review). Additionally or alternatively, code section selection module 206 may provide an application program interface (API) with which the reviewer can provide the results of the review. In some embodiments, code section selection module may provide an API with which a reviewer, such as an automated process (e.g., executing application program, etc.) may conduct an automated review of the selected candidate code section and provide the results of the review.

Code section selection module 206 may update or retrain the error classifier (e.g., the current error classifier) based on the discrete review of the selected candidate code section. The updated or retrained error classifier becomes the “new”, current error classifier. Accordingly, with repeated iterations of the updating or retraining (the active learning aspect), the error classifier may become more efficient.

Automated code review module 208 may be configured to generate an automated review of the source code under review utilizing the current error classifier. As described herein, the generated automated review may incorporate aspects of one or more discrete reviews of the source code under review and/or snippets or sections of the source code under review. Automated code review module 208 may provide one or more suitable interfaces, such as, by way of example, a GUI, an API, etc., with which the results of the automated review may be out and/or accessed.

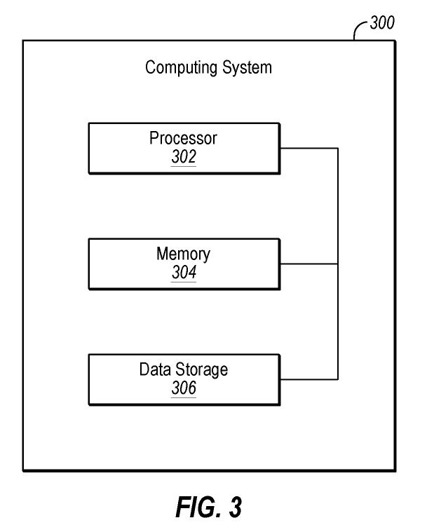

FIG. 3 illustrates selected components of an example general purpose computing system 300, which may be used to provide active learning source code review, arranged in accordance with at least some embodiments described herein. Computing system 300 may be configured to implement or direct one or more operations associated with a feature extraction module (e.g., feature extraction module 202 of FIG. 2), an error classifier training module (e.g., error classifier training module 204 of FIG. 2), a code section selection module (e.g., code section selection module 206 of FIG. 2), and an automated code review module (e.g., automated code review module 208 of FIG. 2). Computing system 300 may include a processor 302, a memory 304, and a data storage 306. Processor 302, memory 304, and data storage 306 may be communicatively coupled.

In general, processor 302 may include any suitable special-purpose or general-purpose computer, computing entity, or computing or processing device including various computer hardware, firmware, or software modules, and may be configured to execute instructions, such as program instructions, stored on any applicable computer-readable storage media. For example, processor 302 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, processor 302 may include any number of processors and/or processor cores configured to, individually or collectively, perform or direct performance of any number of operations described in the present disclosure. Additionally, one or more of the processors may be present on one or more different electronic devices, such as different servers.

In some embodiments, processor 302 may be configured to interpret and/or execute program instructions and/or process data stored in memory 304, data storage 306, or memory 304 and data storage 306. In some embodiments, processor 302 may fetch program instructions from data storage 306 and load the program instructions in memory 304. After the program instructions are loaded into memory 304, processor 302 may execute the program instructions.

For example, in some embodiments, any one or more of the feature extraction module, the error classifier training module, the code section selection module, and the automated code review module may be included in data storage 306 as program instructions. Processor 302 may fetch some or all of the program instructions from the data storage 306 and may load the fetched program instructions in memory 304. Subsequent to loading the program instructions into memory 304, processor 302 may execute the program instructions such that the computing system may implement the operations as directed by the instructions.

Memory 304 and data storage 306 may include computer-readable storage media for carrying or having computer-executable instructions or data structures stored thereon. Such computer-readable storage media may include any available media that may be accessed by a general-purpose or special-purpose computer, such as processor 302. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 302 to perform a certain operation or group of operations.

Modifications, additions, or omissions may be made to computing system 300 without departing from the scope of the present disclosure. For example, in some embodiments, computing system 300 may include any number of other components that may not be explicitly illustrated or described herein.

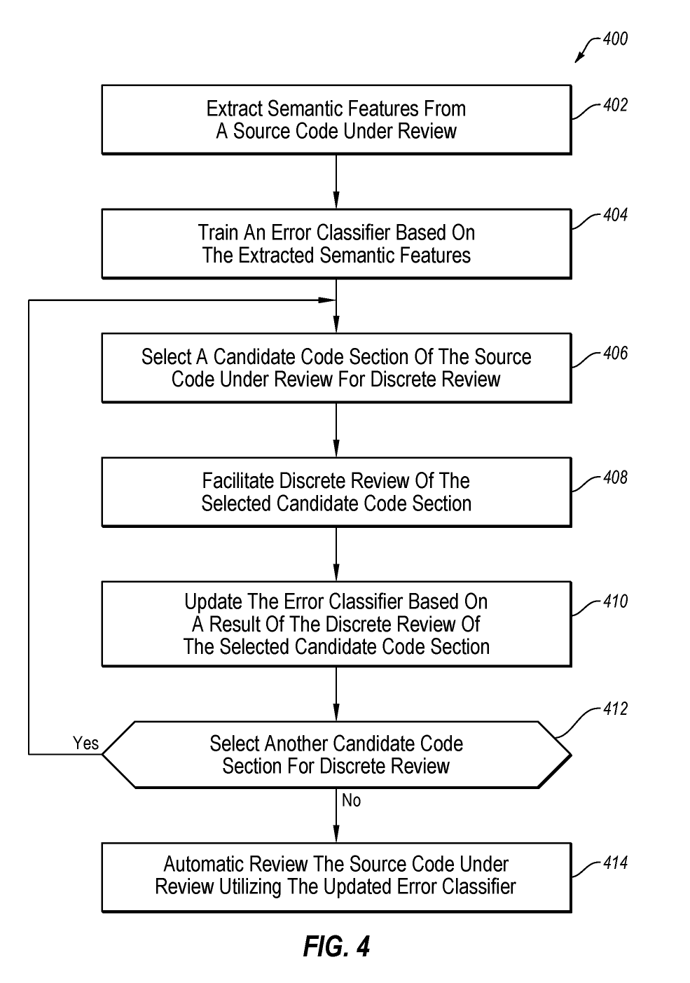

FIG. 4 is a flow diagram 400 that illustrates an example process to provide source code review utilizing active learning that may be performed by a computing system such as the computing system of FIG. 3, arranged in accordance with at least some embodiments described herein. Example processes and methods may include one or more operations, functions or actions as illustrated by one or more of blocks 402, 404, 406, 408, 410, 412, and/or 414, and may in some embodiments be performed by a computing system such as computing system 300 of FIG. 3. The operations described in blocks 402-414 may also be stored as computer-executable instructions in a computer-readable medium such as memory 304 and/or data storage 306 of computing system 300.

As depicted by flow diagram 400, the example process to provide source code review utilizing active learning may begin with block 402 (“Extract Semantic Features from a Source Code Under Review”), where a feature extraction component (for example, feature extraction module 202) of an active learning source code review framework (for example, active learning source code review system 200) may receive source code that is to be reviewed utilizing the framework, and extract semantic code features from the received source code (the source code under review). For example, the feature extraction component may be configured to use graphical models to extract the semantic code features from the source code under review.

Block 402 may be followed by block 404 (“Train an Error Classifier based on the Extracted Semantic Code Features”), where an error classifier training component (for example, error classifier training module 204) of the active learning source code review framework may train a probabilistic classifier to predict probabilities of different types of errors in source code. The error classifier training component may be configured to use the semantic code features extracted by the feature extraction component in block 402 to train the error classifier.

Block 404 may be followed by block 406 (“Select a Candidate Code Section of the Source Code Under Review for Discrete Review”), where an active selection component (for example, code section selection module 206) of the active learning source code review framework may select a code section from the source code under review for discrete review. For example, the active selection component may be configured to identify the code sections in the source code under review that may benefit from discrete reviews (the candidate code sections), and select one of these identified candidate code sections to be discretely reviewed (a selected candidate code section). For example, a candidate code section may be selected based on a predicted cost associated with a discrete review of the selected candidate code section. The predicted cost may be an estimate of a measure of time needed to perform the discrete review. In another example, a candidate code section may be selected based on a comparison of a value provided by a discrete review of the candidate code section and a cost associated with the discrete review of the candidate code section. In a further example, a candidate code section may be selected based on an effect of a discrete review of the candidate code section to a total cost associated with the automated review of the source code under review. The effect of the discrete review may decrease the total cost associated with the automated review of the source code under review using an updated error classifier.

Block 406 may be followed by block 408 (“Facilitate Discrete Review of the Selected Candidate Code Section”), where the active selection component may facilitate a discrete review of the selected candidate code section. For example, the active selection component may be configured to provide a GUI with which a user can conduct a manual review of the selected candidate code section, and provide the error annotation/review resulting from the discrete review. In another example, the active selection component may be configured to provide an API with which a user may conduct an automated review of the selected candidate code section.

Block 408 may be followed by block 410 (“Update the Error Classifier based on a Result of the Discrete Review of the Selected Candidate Code Section”), where the active selection component may update the error classifier using the results of the discrete review of the selected candidate code section obtained in block 408. The updating may retrain the error classifier to predict probabilities of different types of errors in source code based on both the extracted semantic code features (block 404) and the results of the discrete review (block 408).

Block 410 may be followed by decision block 412 (“Select Another Candidate Code Section for Discrete Review?”), where the active selection component may determine whether to select another code section for the source code under review for discrete review. For example, the determination may be based on a desired performance level of the active learning source code review framework. If the active selection component determines to select another code section for discrete review, decision block 412 may be followed by block 406 where the active selection component may select another code section of the source code under review for discrete review.

Otherwise, decision block 412 may be followed by block 414 (“Automatic Review the Source Code Under Review Utilizing the Updated Error Classifier”), where a code review component (for example, automated code review module 208) of the active learning source code review framework may conduct an automated review of the source code under review using the updated error classifier (for example, the error classifier updated in block 410). Thus, the automated review of the source code under review includes aspects of discrete reviews of one or more code sections of the source code under review.

As indicated above, the embodiments described in the present disclosure may include the use of a special purpose or general purpose computer (e.g., processor 302 of FIG. 3) including various computer hardware or software modules, as discussed in greater detail herein. Further, as indicated above, embodiments described in the present disclosure may be implemented using computer-readable media (e.g., the memory 304 of FIG. 3) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method to review source code performed by a computing system including a processor, the method comprising:
extract semantic code features from a source code under review;
training an error classifier based on the extracted semantic code features;
selecting a candidate code section of the source code under review for discrete review;
facilitating discrete review of the selected candidate code section;
updating the error classifier based on a result of the discrete review of the selected candidate code section; and
generating an automated review of the source code under review based on the updating of the error classifier.

2. The method of claim 1, further comprising iterating the selecting a candidate code section of the source code under review for discrete review, facilitating discrete review of the selected candidate code section, and updating the error classifier based on a result of the discrete review of the selected candidate code section.

3. The method of claim 1, wherein selecting a candidate code section is based on a predicted cost associated with a discrete review of the selected candidate code section.

4. The method of claim 3, wherein the predicted cost is an estimate of a measure of time needed to perform the discrete review.

5. The method of claim 4, wherein the predicted cost is automatically determined.

6. The method of claim 1, wherein selecting a candidate code section is based on a comparison of a value provided by a discrete review of the candidate code section and a cost associated with the discrete review of the candidate code section.

7. The method of claim 1, wherein selecting a candidate code section is based on an effect of a discrete review of the candidate code section to a total cost associated with the automated review of the source code under review.

8. The method of claim 7, wherein the effect of the discrete review decreases the total cost associated with the automated review of the source code under review, the automated review being based on the updating of the error classifier.

9. The method of claim 1, wherein facilitating discrete review of the identified candidate code section allows for an automated review.

10. The method of claim 1, wherein facilitating discrete review of the identified candidate code section allows for a manual review.

11. A system configured to review source code, the system comprising:
a memory configured to store instructions; and
a processor configured to execute a feature extraction module, an error classifier training module, a code section selection module, and an automated code review module in conjunction with the instructions, wherein:
the feature extraction module is configured to extract semantic code features from a source code under review;
the error classifier training module is configured to train an error classifier based on the extracted semantic code features;
the code section selection module is configured to:
select a candidate code section of the source code under review for discrete review;
facilitate discrete review of the selected candidate code section; and
update the error classifier based on the discrete review of the selected candidate code section; and
the automated code review module is configured to generate an automated review of the source code under review based on the update of the error classifier.

12. The system of claim 11, wherein the feature extraction module is configured to utilize a graphical model to extract the semantic code features from the source code under review.

13. The system of claim 11, wherein the selected candidate code section is one of a plurality of code sections in the source code under review that may benefit from a discrete review.

14. The system of claim 11, wherein the selection of the candidate code section is based on an expected change to a total cost associated with the automated review of the source code under review based on the update of the error classifier.

15. The system of claim 14, wherein the expected change exceeds a specific value.

16. The system of claim 11, wherein the code section selection module is further configured to iterate select a candidate code section of the source code under review for discrete review, facilitate discrete review of the selected candidate code section, and update the error classifier based on a result of the discrete review of the selected candidate code section.

17. A non-transitory computer-readable storage media storing thereon instructions that, in response to execution by a processor, causes the processor to:
extract semantic code features from a source code under review;
train an error classifier based on the extracted semantic code features;
select a candidate code section of the source code under review for discrete review;
facilitate discrete review the selected candidate code section;
update the error classifier based on a result of the discrete review of the selected candidate code section; and
generate an automated review of the source code under review based on the update of the error classifier.

18. The non-transitory computer-readable storage media of claim 17, wherein select a candidate code section is based on a comparison of a value provided by a discrete review of the candidate code section and a cost associated with the discrete review of the candidate code section.

19. The non-transitory computer-readable storage media of claim 17, wherein select a candidate code section is based on a determination as to whether a difference in a value provided by a discrete review of the candidate code section and a cost associated with the discrete review of the candidate code section exceeds a specific value.

20. The non-transitory computer-readable storage media of claim 17, further storing thereon instructions that, in response to execution by the processor, causes the processor to iterate select a candidate code section of the source code under review for discrete review, facilitate discrete review of the selected candidate code section, and update the error classifier based on a result of the discrete review of the selected candidate code section.
